(19) United States
(12) Patent Application Publication
(10) Pub. No.: US 2015/0051732 A1
(43) Pub. Date: Feb. 19, 2015

(54) Manually Controlled Assistance Device for a Robot

(71) Applicant: Robotiques 3 Dimensions RB3D, Auxerre (FR)

(72) Inventors: Serge Grygorowicz, Gy l'Eveque (FR); Ludovic Surgot, Mezire (FR)

(73) Assignee: Robotiques 3 Dimensions RB3D, Auxerre (FR)

(21) Appl. No.: 14/388,348

(22) PCT Filed: Mar. 25, 2013
(86) PCT No.: PCT/EP2013/056321

§ 371 Date: Sep. 26, 2014

(30) Foreign Application Priority Data
Mar. 26, 2012 (FR) 1252694

(51) Int. Cl. B25J 9/16

(52) U.S. Cl. CPC B25J 9/161; Y10S 901/46; Y10S 901/09
USPC 700/257; 901/46; 901/9

(57) ABSTRACT

The present invention relates to an assistance device with which a robotic arm (B) is to be provided, said robotic arm being controlled by an operator (H) and having a tool (m) at the end thereof, characterized in that it includes a control handle (1), which is mounted via a ball-and-socket joint (R3) so as to form an extension of the arm (B) while being offset relative to the tool (m), and a force sensor (4) which is coupled to the robot and ensures the continuous detection, from the handle (1), of the intentional forces of the operator for controlling both the direction and the force of the tool (m). The invention also relates to the collaborative robot provided with the device of the invention, and to the use thereof.

The present invention relates to a manually controlled assistance device for a robot as well as a collaborative robot equipped with such a device and its industrial application.

Such a device is in particular applicable in industrial robotics to assist a robot's controller during finishing, part assembly or machining tasks requiring both great precision and significant forces exerted in multiple directions.

These tasks generally pose acute fatigue problems for personnel both due to the high level of preparation and the need for operators to continuously ensure that the robotic arm is balanced in all orientations.

These constraints are then heavier and more delicate inasmuch as the arm is subject, due to its considerable inertia and the load of the tool, to high movement speeds and very strong accelerations that may thus cause serious accidents.

Furthermore, the operator must jointly monitor the proper movement of the tool mounted at the end of the arm as well as its correct positioning relative to the mechanical environment of the work zone, which requires very significant and long attention and consequently increases the unpleasant nature of the task.

The present invention aims to resolve these ergonomic, safety and efficiency problems in a satisfactory manner by proposing a solution making it possible to offer the operator very precise mechanical assistance combined with strengthened security.

This aim is achieved according to the invention using an assistance device that comprises a control handle mounted via a ball-and-socket joint on the arm of the robot while being offset relative to the tool on the one hand, and a force sensor coupled to the robot and ensuring continuous detection, from the handle, of the intentional forces exerted by the operator in order to maneuver the tool both in terms of direction and force, on the other hand.

According to one advantageous feature, the tool is associated with a motor mounted on a mandrel connected upstream from the ball-and-socket joint and bearing said control handle.

According to another advantageous feature, the force sensor is positioned between the handle and the end of the arm.

Preferably, the device comprises a vibration insulating element mounted inserted between the handle and the tool.

According to a first alternative of the invention, the control handle includes a status sensor continuously detecting orders and/or any problems from the operator in running the tool.

According to another alternative, the handle includes a detector detecting the presence of the operator's hand.

According to one specific feature, the status sensor detects the stop orders and start orders as well as the twitches of the operator's hand.

Preferably, the status sensor is associated with a limiter limiting the movement speed of the robotic arm.

According to one advantageous feature, the handle includes at least one pushbutton sensitive to ,pressure from the fingers and connected to the status sensor.

Preferably, the handle acts directly on a safety automaton.

Another object of the invention is a collaborative robot comprising an arm whereof the end bears a tool and is equipped with the device according to the invention, said arms being generally C-shaped.

Still another object of the invention is a use of the collaborative robot in which the operator places himself at the end of the robotic arm while being embraced by the latter and drives the robot manually and using only the control handle.

The device according to the invention is mounted directly on the robotic arm, which makes it possible to secure the operation of the machine, since it is the direct detection of the operator's intentions in performing his task that controls the movement of the arms.

Furthermore, because the device is directly engaged with the operator's hand, the detection of the latter's accidental difficulties, detected by a release or simple twitch, suffices to immobilize the robotic arm, which makes it possible to eliminate the presence of a specific emergency stop member.

The device according to the invention thus guarantees that the work of the tool will be done at speeds comparable to those of a human arm while giving the operator a controlled amplification of his mechanical forces.

The increase in comfort is remarkable due to the fact that the device is offset at the end of the arm and the operator's hand is thus insulated from the tool and is no longer directly subject to the vibrations in particular generated by its high-speed rotation.

The speed at which the tasks are performed is thus comparable to that of the human arm, which improves the comfort and quality of the work.

Lastly, the device according to the invention allows the presence of personnel in immediate proximity to the robot without creating any accident risk, which in particular simplifies the performance of maintenance operations.

The invention will be better understood upon reading the following description, accompanied by the drawings, in which:

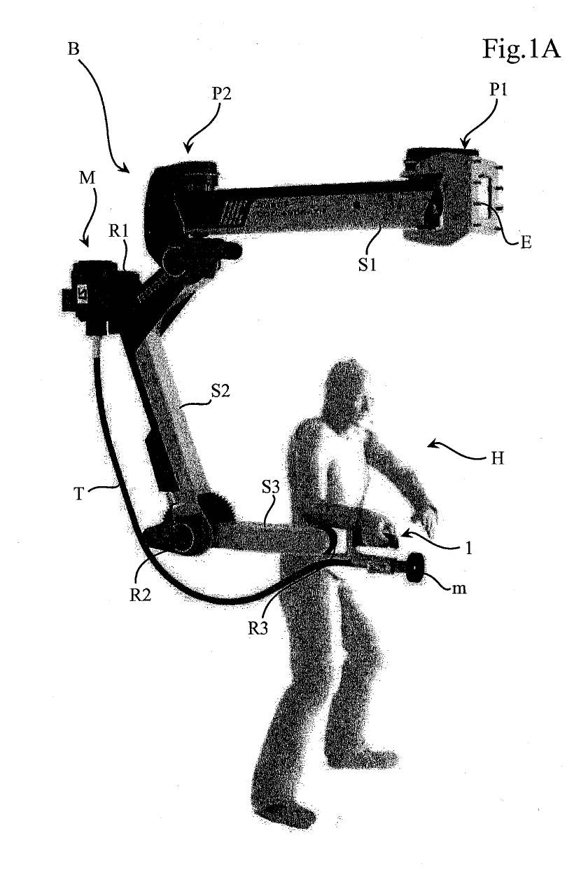

FIGS. 1A, 1B and 1C show an overall and detailed perspective view (FIG. 1C), respectively, of one embodiment of the collaborative robot of the invention with an operator (FIG. 1A).

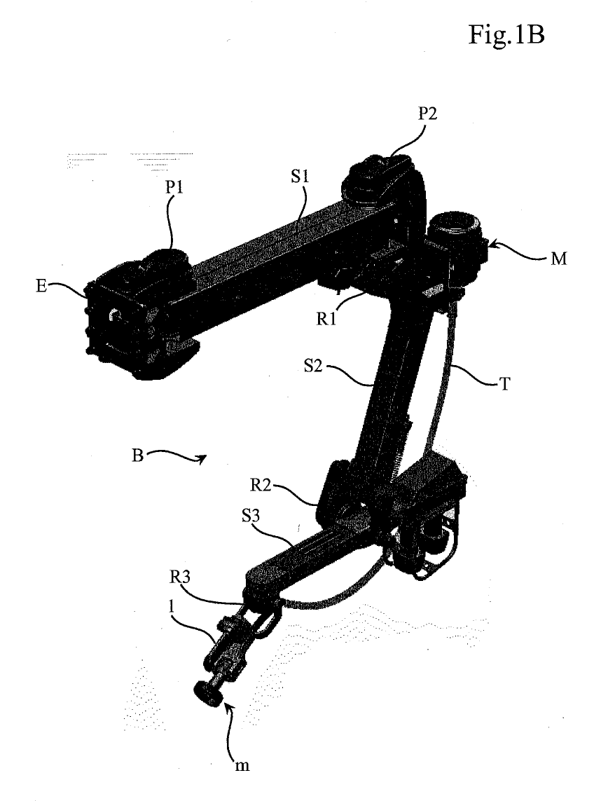

FIG. 2 shows a partial perspective view of one embodiment of the assistance device according to the invention.

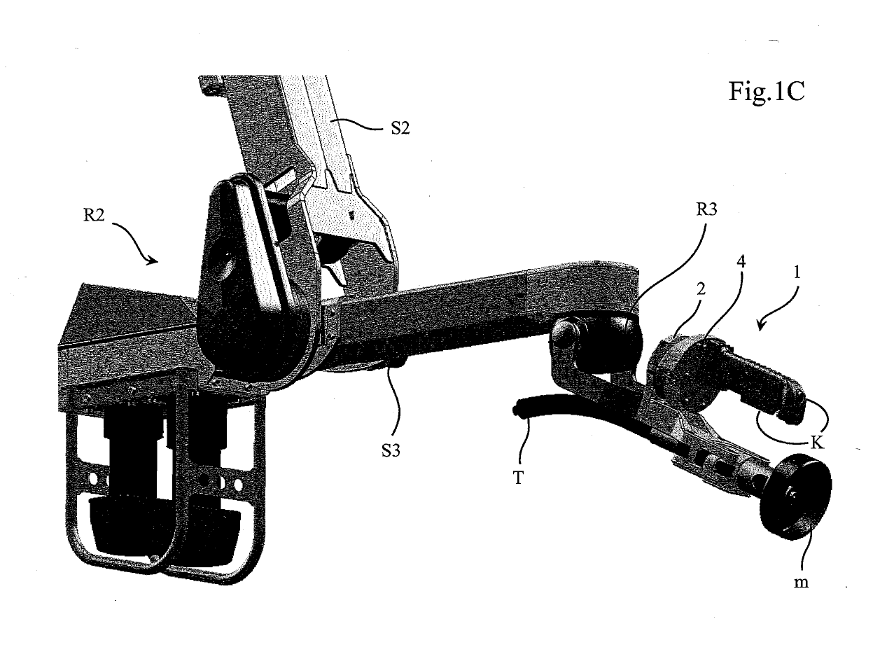

FIG. 3 shows a diagrammatic view of the embodiment of FIG. 1.

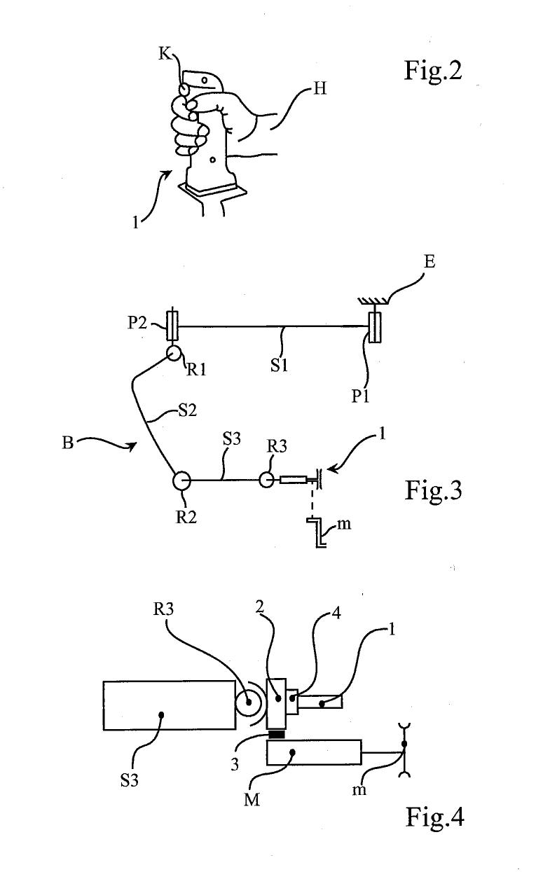

FIG. 4 shows a diagrammatic view of the structure of the assistance device according to the invention.

The robot shown in FIGS. 1 and 3 traditionally comprises an arm B fastened by a first end on a partition or on a base E, and bearing a motorized tool M at its other end. This arm B is made up, like a human arm, of sections or segments S1, S2, S3 articulated to each other using pivots P1, P2 and/or ball-and-socket joints R1, R2, R3.

The arm B is equipped, according to the invention, with an assistance device for the operator H responsible for performing a precise task using the tool m.

This device comprises a control handle 1 mounted on the arm B of the ball-and-socket joint R3 acting as a human wrist while upstream, the segment S3 forms the equivalent of a forearm.

The handle 1, which assumes the form of a sleeve, is offset relative to the tool M, while being mounted on a mandrel 2 that is connected upstream, via the ball-and-socket joint R3, in the extension of the segment S3 of the arm B.

The handle and therefore the forearm of the operator are thus parallel to the tool holder, which facilitates the operator's task and make the operations more precise.

The mandrel 2 bears either directly on the motor M of the tool m (FIG. 4) or transmission means T for transmitting movement (FIGS. 1A, 1B and 1C) between the motor M, which is then incorporated into the arm and the tool m.

If applicable, an element 3 providing vibration insulation for the handle will be mounted inserted between the handle 1 and the tool m.

Still according to the invention, the assistance device further comprises a force sensor 4 coupled to the robot and ensuring the continuous detection, from the handle 1, of the intentional forces from the operator to maneuver the tool m, both in terms of direction and force.

The force sensor 4 is positioned between the handle 1 and the end of the arm B.

The handle 1 also incorporates a status sensor (not shown) continuously detecting the orders from the operator H.

More specifically, the status sensor reacts to the stop orders and start orders and/or any difficulties from the operator H in running the tool m, such as twitches of the hand related to stress, handling errors or an accident.

The status sensor is sensitive to direct contact with the operator's hand due to the fact that its interface is made up of actuators in the form of pushbuttons K borne by the handle 1.

The handle 1 is designed to be grasped by the operator's hand like a joystick, as shown by FIG. 2, the fingers exerting variable pressure on the buttons K based on the circumstances and nature of the task.

In the figures, the tool m is suitable for brushing and/or polishing metal parts (not shown).

The sensor is capable of detecting three respective main statuses: releasing the pressure of the fingers on the buttons K in a stopped state; pushing in at a medium depth (substantially midway) corresponding to a normal working state, and strong pressure (twitching) bringing the button to the end of its travel or at least beyond its middle position in a so-called critical state.

The control handle acts, via the incorporated status sensor, on a security automaton.

According to one alternative, the handle is further provided with a detector for detecting the presence of the hand that is coupled to the security automaton. That detector is either made up of a thin element positioned on the surface of the handle and that is sensitive in contact with the hand, or an additional key situated in the gripping zone of the handle.

The operation of the device is therefore very intuitive, since the operator need only place his hand on the handle to activate the status sensor and still manually move that handle to jointly activate the force sensor.

The signal delivered by the sensors is sent to a computer that commands and controls the movements of the robotic arm B such that despite its inertia, it follows the intentions of the operator's hand very precisely, with sufficient flexibly and faithfully.

The position of the two sensors in contact with or near the hand places the operator in the immediate environment of the arm, which makes it possible to reduce the risk of collisions or impacts.

If the operator releases the handle 1, the robot stops automatically and immediately, and the same is true if the operator's hand twitches on the handle.

If the pressure of the figures is located in the acceptable range, the robot is available, but the speed of its movements is controlled and regulated.

Under such conditions, the operator is assisted in a safe manner and benefits from an adjusted amplification of his efforts while working with a very low vibration level.

These ergonomic qualities can also be further improved owing to a suitable profile of the handle and the C shape of the arm B making it possible to wind around or embrace the operator by positioning the segments at his back.

The status sensor is preferably associated with a limiter limiting the movement speed of the robotic arm to avoid sudden movements.

1. An assistance device designed to equip a robotic arm controlled by an operator and bearing a tool at its end, wherein a control handle is mounted in the extension of the arm via a ball-and-socket joint while being offset relative to the tool on the one hand, and a force sensor coupled to the robot and ensuring continuous detection, from the handle, of the intentional forces exerted by the operator in order to maneuver the tool both in terms of direction and force, on the other hand.

2. The device according to claim 1, wherein said tool is associated with a motor mounted on a mandrel connected upstream from the ball-and-socket joint and bearing said control handle.

3. The device according to claim 1, wherein said force sensor is positioned between the handle and the end of the arm.

4. The device according to claim 1, wherein said device comprises a vibration insulating element mounted inserted between the handle and the tool.

5. The device according to claim 1, wherein said handle includes a status sensor continuously detecting orders and any problems from the operator in running the tool.

6. The device according to claim 5, wherein said status sensor detects the stop orders and start orders as well as the twitches of the operator's hand.

7. The device according to claim 5, wherein said status sensor is associated with a limiter limiting the movement speed of the robotic arm.

8. The device according to claim 5, wherein said handle includes at least one pushbutton sensitive to pressure from the fingers and connected to the status sensor.

9. The device according to claim 5, wherein said handle includes a detector detecting the presence of the operator's hand.

10. The device according to claim 1, wherein said control handle acts directly on a safety automaton.

11. A collaborative robot comprising an arm whereof the end bears a tool and is equipped with the device according to claim 1, wherein said arm is generally C-shaped.

12. A use of a robot according to claim 11, wherein said operator places himself at the end of the robotic arm while being embraced by the latter and drives the robot manually and using only the control handle.
